(19) United States
(12) Patent Application Publication
(10) Pub. No.: US 2012/0251794 A1
(43) Pub. Date: Oct. 4, 2012

(54) PLATE HAVING A CARBON NANOTUBE LAYER AND MANUFACTURING METHOD THEREOF

(76) Inventor: Hsin Yuan MIAO, Taichung City (TW)

(21) Appl. No.: 13/075,855

(22) Filed: Mar. 30, 2011

(51) Int. Cl. B32B 3/10; B05D 3/10; B82Y 30/00

(52) U.S. Cl. 428/195.1; 427/343; 977/742

(57) ABSTRACT

The present invention provides a method for making a sheet of a carbon nanotube (CNT) layer. First, a CNT solution is provided. A substrate is also provided. The substrate is then covered by the CNT solution, and a CNT layer is formed on the substrate through vacuum filtration. The CNT layer is cleaned with an organic chemical solution, and the CNT layer is cleaned with water. Finally, water is removed from the CNT layer. Additionally, in the step of vacuum filtration, a whirlpool is created in the CNT solution.

### BACKGROUND OF THE INVENTION

1. Field of the Invention

The present invention is related to a plate or sheet having a carbon nanotube (CNT) layer and a manufacturing method thereof. In particular, the present invention relates to a novel buckypaper and a manufacturing method thereof.

2. Description of the Related Art

A buckypaper is made of carbon nanotubes (CNTs) and is expressed as a “paper.”

The weight of a volume of buckypaper materials is ten times less than that of the same volume of steel. However, a composition material made of stacked buckypaper materials provides stiffness five hundred times that of steel. In addition, a buckypaper provides good conductivity, comparable to copper or silicon, and also provides good heat-dissipating qualities, comparable to iron or brass.

A traditional method for manufacturing buckypaper is disclosed in a U.S. Pat. No. 6,790,425. The disadvantage of this method is that the buckypaper has an asymmetric distribution of CNTs. Such a characteristic of a traditionally-made buckypaper limits the electromagnetic behavior of buckypaper.

Therefore, the present invention provides a novel buckypaper, and is used to eliminate the disadvantage of the traditional buckypaper.

### BRIEF SUMMARY OF THE INVENTION

The present invention provides a plate having a carbon nanotube layer. The plate may have a substrate that is non-conductive and a CNT layer disposed on the substrate. In addition, the CNT layer is composed of many carbon nanotubes. The carbon nanotubes are placed in an orderly manner on the substrate. At least two carbon nanotubes are arranged along a curve. The surface of the CNT layer has a whirlpool pattern.

The present invention also provides a method for manufacturing a plate having a CNT layer. The method comprises providing a CNT solution, wherein the CNT solution comprises a plurality of CNTs and a liquid or a liquid-phase material. A substrate is provided, wherein the substrate is non-conductive and the liquid or liquid-phase material can penetrate the substrate. The substrate is covered with the CNT solution. The liquid of the CNT solution penetrates the substrate to form a CNT layer on the substrate. An organic compound solution is used to remove the liquid from the CNT layer, and a cleaner is used to remove the organic compound solution from the CNT layer. The cleaner is removed from the CNT layer. Additionally, during the step of letting the liquid of the CNT solution penetrate the substrate to form a CNT layer on the substrate, a whirlpool is created in the CNT solution.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a plate having a carbon nanotube layer in accordance with the present invention;

FIG. 2 shows a basic illustration of the distribution of carbon nanotubes; and

FIG. 3 shows the top view of one plate from one of the embodiments of the present invention.

### DETAILED DESCRIPTION OF THE PREFERRED EMBODIMENTS

A plate having a carbon nanotube layer

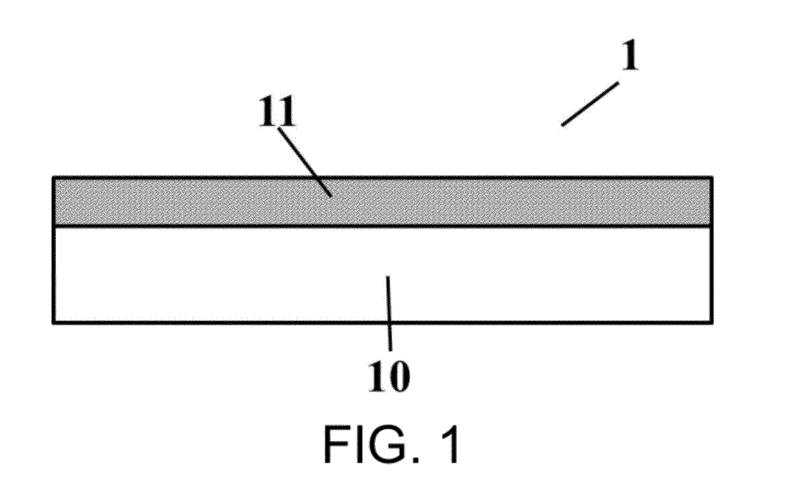

As shown in FIG. 1, the present invention provides a plate 1 having a CNT layer. The plate 1 comprises a substrate 10 and a CNT layer 11.

The substrate 10 may be non-conductive, meaning that the resistant coefficient of the substrate 10 is very high. The substrate 10 may be composed of a paper. The substrate 10 may also be composed of polymer materials. The shape of the substrate 10 is circular, rectangular, or of any other shape.

The CNT layer 11 is placed on the substrate 10. The CNT layer 11 is composed of many carbon nanotubes.

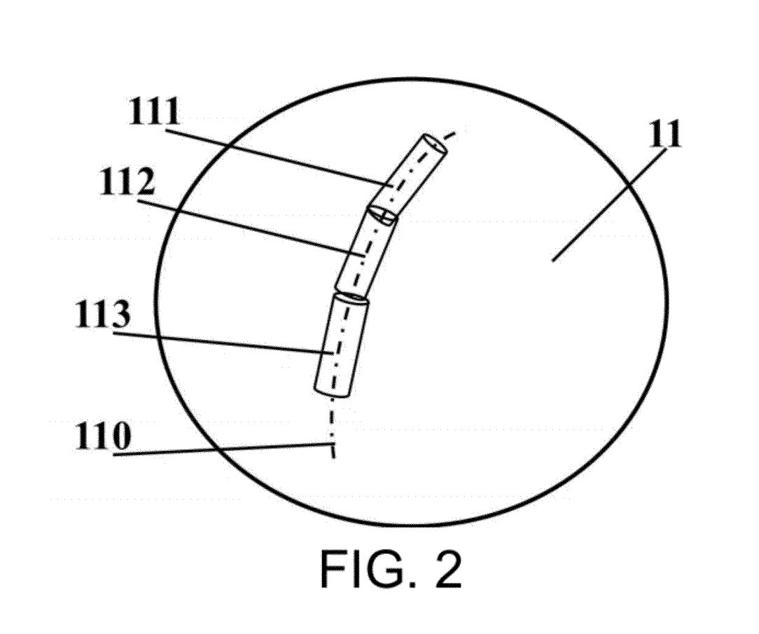

The carbon nanotubes are allocated or arranged in an orderly manner on the substrate 11. As shown in FIG. 2, for example, carbon nanotubes 111, 112, 113 in the CNT layer 11_are placed in an orderly manner. At least two carbon nanotubes 111, 112, 113 are arranged along a curve 110 that is not physically seen on the surface of the CNT layer 11.

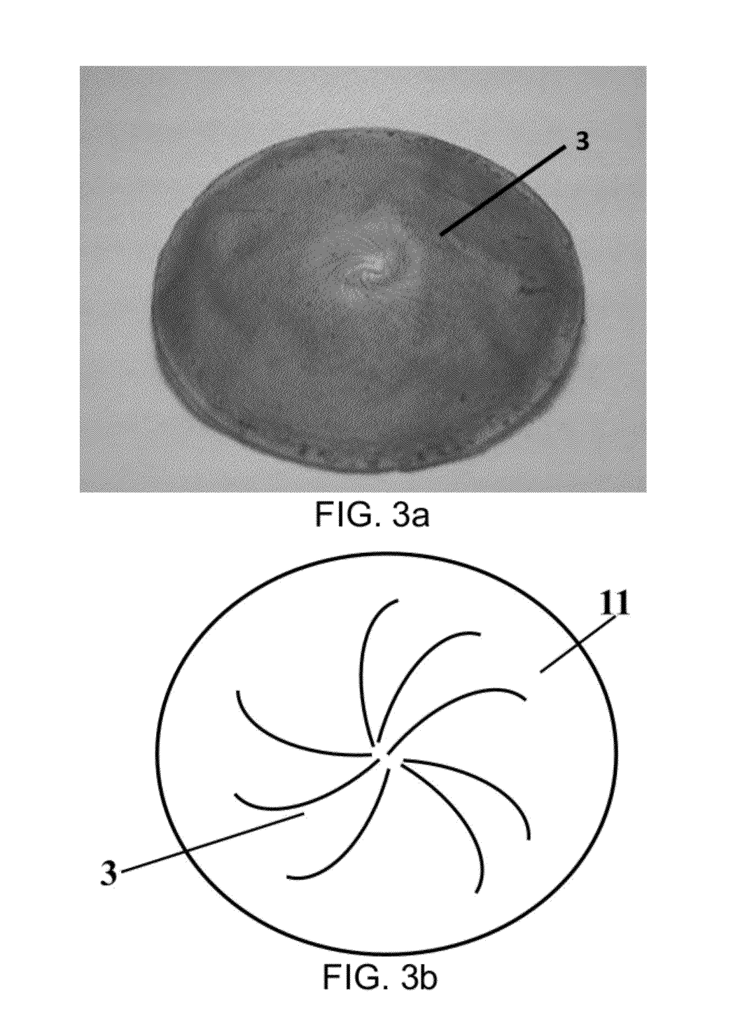

As shown in FIG. 3(b), the surface of the CNT layer 11 has a whirlpool pattern 3. FIG. 3(a) shows a photograph of the whirlpool pattern 3 of the CNT layer 11.

2. A Method for Manufacturing a Plate Having a CNT Layer

The present invention further provides a method for manufacturing a plate 1 having a CNT layer. The method comprises providing a CNT solution, wherein the CNT solution comprises a liquid or a liquid-phase material. A substrate is provided. The substrate is covered with the CNT solution and the liquid of the CNT solution penetrates the substrate to form a CNT layer on the substrate. An organic compound solution is used to remove the liquid from the CNT layer, and a cleaner is used to remove the organic compound solution from the CNT layer. The cleaner is removed from the CNT layer.

In the step of providing a CNT solution, the CNT solution comprises many carbon nanotubes and a liquid or a liquid-phase material. The liquid or liquid-phase material may include a surfactant and a solvent. The surfactant may be Triton X-100. The solvent may be water or another hydrophilic solution. The surfactant suspends the carbon nanotubes in the solvent.

In the step of providing a substrate, the substrate is non-conductive. The substrate may be composed of a paper or polymer material. The shape of the substrate may be circular, rectangular, or any other shape. In addition, the liquid of the CNT solution may penetrate the substrate. In other words, a large portion of the carbon nanotubes may remain on the substrate. The substrate may be a filter material that is capable of separating the carbon nanotubes from the liquid.

In the step of covering the substrate with the CNT solution, the method of the present invention further comprises providing a container, leaving the substrate on the bottom of the container, and pouring the CNT solution into the container.

In the step of letting the liquid penetrate the substrate, a CNT layer will be formed on the substrate. In this step, the method of the present invention further comprises making the atmospheric pressure above the substrate higher than the atmospheric pressure below the substrate. Because of the pressure difference, the speed at which the liquid penetrates will increase. In addition, in this step, the method of the present invention further comprises creating a whirlpool in the CNT solution. For example, a mixer can be used to create the whirlpool. The mixer has a flow impeller, and controlling the rotating speed of the flow impeller can change the pattern of the whirlpool.

In the step of using an organic compound solution to remove the liquid from the CNT layer, the organic compound solution may be a solution containing isopropanol.

In the step of using a cleaner to remove the organic compound solution from the CNT layer, the cleaner may be water.

In the step of removing the cleaner from the CNT layer, the method of the present invention further comprises heating the CNT layer and the substrate. In other words, by the mechanism of mass transfer, the cleaner will be removed from the CNT layer.

More details of the embodiments of the present invention are illustrated as follows.

3. The Production of a Buckypaper

The present invention further provides a method for making a buckypaper.

First, a CNT solution is provided. The preparation of the CNT solution follows the steps:

(1) Add 0.03 g of carbon nanotubes having a length of 10 to 40 μm and 0.3 g Triton X-100 into a container having distilled water, so as to form a 0.25 liter CNT solution. The carbon nanotubes may be a multi-walled carbon nanotube (MWCNT), or a single-walled carbon nanotube (SWCNT).

(2) Place the container in an ultrasonic processor. Use ultrasonic power of 63 watts to disperse the carbon nanotubes. The process will take 5 minutes. In this step, the carbon nanotubes will not agglomerate in the solvent. It should be noted that an increase of ultrasonic power can improve the dispersion of carbon nanotubes but, to some extent, the carbon nanotubes will be broken by the ultrasonic power.

(3) Add distilled water into the container to increase the volume of the CNT solution to 0.5 liters. Next, continue the dispersion process with 63 watt ultrasonic power to disperse the carbon nanotubes for another 20 minutes. After this step, the carbon nanotubes will be more dispersed in the solvent.

(4) Divide the CNT solution of 0.5 liters into five cups, each cup having 0.1 liter of the CNT solution. For each cup, add distilled water to dilute the CNT solution and obtain a CNT solution of 0.4 liters. Next, place each cup in an ultrasonic processor to use ultrasonic power of 63 watts to disperse the carbon nanotubes in the cup. The ultrasonic process takes 30 minutes. After this step, the carbon nanotubes will be more dispersed in the solvent.

(5) Repeat steps (1) to (4) to obtain ten cups, each cup having a CNT solution of 0.4 liters.

After the preparation of a CNT solution, use a vacuum filter to separate the carbon nanotubes from the CNT solution, so that a CNT layer will be formed in the filter paper.

The vacuum filter comprises a porcelain filter and a filtrate container. The porcelain filter is combined with the filtrate container through an elastic tube. The porcelain filter has a tube that is inserted into the filtrate container. The filtrate will flow into the filtrate container through the tube. The filtrate container has a gas-out tube through which the gas in the filtrate container can be sucked from the filtrate container.

Place one filter paper on the porcelain filter. The step of providing a substrate will then be complete.

Pour the 0.4 liter CNT solution mentioned above into the porcelain filter. Then cover the filter paper with the CNT solution. The step of covering the substrate with the CNT solution is now complete.

Next, a vacuum filtration is carried out. Use a pump to remove the gas from inside the filtrate container. The air will start to leave the filtrate container through the gas-out tube. As a result, the carbon nanotubes in the CNT solution will gradually be deposited on the filter paper during the vacuum filtration. In the meantime, create a whirlpool in the CNT solution contained in the porcelain filter. For example, use a mixer to create a whirlpool. This will complete the step of letting the liquid of the CNT solution penetrate the substrate to form a CNT layer.

Pour all ten cups of a CNT solution of 0.4 liters, one by one, into the porcelain filter so as to operate a vacuum filtration. The process will take 10 to 12 hours. A buckypaper can be obtained, and the diameter of the buckypaper is about 4.2 micrometers.

Next, submerge the buckpaper in a solution containing isopropanol. The submerging process will take more than three hours so as to remove the surfactant Triton X-100 from the buckypaper. This will complete the step of using an organic compound solution to remove the liquid from the CNT layer.

Next, remove the buckypaper from the isopropanol solution. Place the buckypaper in moving water to remove isopropanol from the buckypaper. This will complete the step of using a cleaner to remove the organic compound solution from the CNT layer.

Lastly, dry the buckypaper in a baker. The temperature of the baker is 120° Celsius. This step will take 30 minutes. The step of removing the cleaner from the CNT layer will then be done.

By the method mentioned above, a buckypaper is then produced as shown in FIG. 3(a).

4. Verification of Electromagnetic Effects

The key feature of the present invention is that, during a vacuum filtration, a whirlpool will be created in a CNT solution so as to create a whirlpool pattern 3 on the surface of a CNT layer 11, as shown in FIG. 3(b). FIG. 3(a) shows the picture of the whirlpool pattern 3.

Without the step of creating a whirlpool, we only can get a traditional buckypaper.

The buckypaper of the present invention has better electromagnetic effects than a traditional buckypaper. A testing of eddy current measured on the buckypaper of the present invention has been carried to prove the improved electromagnetic effects gained by the buckypaper of the present invention. Table 1 shows the comparison of the buckypaper of the present invention and the traditionally-made buckypaper. Table 1 shows the improvement reached by the buckypaper of the present invention in comparison with the traditional buckypaper.

TABLE 1
Comparison of the Buckypaper of the Present Invention and Traditional
Buckypaper

| | The increase of |
|---|---|
| | eddy current of the |
| | currently-invented buckypaper |
| Rotating speed of the flow impeller of the | to the traditionally-made |
| mixer (round per minute, rpm) | buckypaper (percentage, %) |
| 80 | 17 |
| 160 | 69 |
| 240 | 164 |

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A plate having a carbon nanotube layer, comprising:
a substrate; and
a carbon nanotube layer disposed on the substrate;
wherein the carbon nanotube layer has a plurality of carbon nanotubes;
wherein the carbon nanotubes are allocated in an orderly manner on the substrate;
wherein at least two carbon nanotubes are allocated along a curve; and
wherein a surface of the carbon nanotube layer has a whirlpool pattern.

2. A method for manufacturing a plate having a carbon nanotube layer, comprising:
providing a carbon nanotube solution, wherein the carbon nanotube solution has a plurality of carbon nanotubes and a liquid;
providing a substrate, wherein the substrate is non-conductive, and the liquid can penetrate the substrate;
covering the substrate with the carbon nanotube solution;
letting the liquid of the carbon nanotube solution penetrate the substrate to form a carbon nanotube layer on the substrate;
using an organic compound solution to remove the liquid from the carbon nanotube layer;
using a cleaner to remove the organic compound solution from the carbon nanotube layer; and
removing the cleaner from the carbon nanotube layer;
wherein, during the step of letting the liquid of the carbon nanotube solution penetrate the substrate to form a carbon nanotube layer on the substrate, a whirlpool is created in the carbon nanotube solution.

3. The method as claimed in claim 2, wherein the liquid comprises a surfactant and a solvent, and wherein the surfactant allows the carbon nanotubes to be suspended in the solvent.

4. The method as claimed in claim 3, wherein the surfactant is Triton X-100.

5. The method as claimed in claim 2, wherein the step of covering the substrate with the carbon nanotube solution comprises:
providing a container;
placing the substrate on the bottom of the container; and
pouring the carbon nanotube solution into the container.

6. The method as claimed in claim 2, wherein the step of letting the liquid of the carbon nanotube solution penetrate the substrate comprises making the atmospheric pressure above the substrate higher than the atmospheric pressure below the substrate.

7. The method as claimed in claim 2, wherein the step of letting the liquid of the carbon nanotube solution penetrate the substrate comprises using a mixer to create the whirlpool.

8. The method as claimed in claim 2, wherein the organic compound solution is a solution containing isopropanol.

9. The method as claimed in claim 2, wherein the cleaner is water.

10. The method as claimed in claim 2, wherein the step of removing the cleaner from the carbon nanotube layer comprises heating the carbon nanotube layer and the substrate.
